(19) United States
(12) Patent Application Publication
(10) Pub. No.: US 2009/0201607 A1
(43) Pub. Date: Aug. 13, 2009

(54) Patterned perpendicular magnetic recording medium and magnetic recording and reproducing apparatus

(75) Inventors: Yousuke Isowaki, Yokohama-Shi (JP); Tomoyuki Maeda, Kawasaki-Shi (JP); Yoshiyuki Kamata, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/320,602

(22) Filed: Jan. 29, 2009

(30) Foreign Application Priority Data
Feb. 5, 2008 (JP) 2008-24903

(51) Int. Cl. G11B 5/127; G11B 5/66

(52) U.S. Cl. 360/110; 428/828; G9B/5.241; G9B/5.04

(57) ABSTRACT

It is made possible to provide a patterned perpendicular magnetic recording medium that has smaller write magnetic field and the variation of magnetic characteristics in the bit regions, generates fewer reversed magnetic domains in the position control information regions of the head, and has excellent thermal stability. A patterned perpendicular magnetic recording medium includes: a nonmagnetic substrate; a soft magnetic base layer formed on the nonmagnetic substrate; a nonmagnetic intermediate layer formed on the soft magnetic base layer; and a perpendicular magnetic recording layer formed on the nonmagnetic intermediate layer, and including a stacked structure of a CoPt-based crystalline film having a Pt content in the range of 5 atomic percent to 35 atomic percent and a rare-earth and transition metal alloy amorphous film formed on the CoPt-based crystalline film. The CoPt-based crystalline film and the rare-earth and transition metal alloy amorphous film are exchange-coupled.

### CROSS-REFERENCE TO RELATED APPLICATION

This application is based upon and claims the benefit of priority from prior Japanese Patent Application No. 2008-24903 filed on Feb. 5, 2008 in Japan, the entire contents of which are incorporated herein by reference.

### BACKGROUND OF THE INVENTION

1. Field of the Invention

The present invention relates to a patterned perpendicular magnetic recording medium, and a magnetic recording and reproducing apparatus.

2. Related Art

In recent years, switching from the in-plane magnetic recording method to the perpendicular magnetic recording method is becoming more and more common in magnetic recording and reproducing apparatuses. In this trend, attention is drawn to patterned media to achieve higher recording density and larger capacity in the future. A patterned medium involves a technique for defining each one bit by recording a recording bit signal on a magnetic dot that is finely-processed in advance.

In a conventional perpendicular magnetic recording medium, higher recording density is achieved through magnetic isolation of the magnetic crystalline grains and a decrease in crystalline grain size due to granulation caused by adding SiO₂ to the CoCrPt-based crystalline film (see JP-A 2002-83411 (KOKAI), for example). However, a decrease in thermal stability that is caused as a conflicting request at the same time has become a problem. An increase in the magnetic anisotropy energy Kᵤ of the magnetic crystalline grains is also being considered to secure high thermal stability. However, an increase of write magnetic fields that is to be caused by the increase in the magnetic anisotropy energy is a concern.

On the other hand, a patterned medium may include a so-called continuous film material having strong magnetic coupling between the magnetic crystalline grains of the magnetic recording layer, unlike a conventional perpendicular magnetic recording medium. With the use of such a material, it is possible to maintain the bistability of the magnetization direction by virtue of the volume of the finely-processed dots. Accordingly, higher thermal stability can be secured, and an increase in the magnetic anisotropy energy Kᵤ can be more effectively prevented than in the case of a film including a granular structure.

It is also possible to form a patterned medium, with the use of a CoCrPt-based granular film that is normally used in a conventional perpendicular magnetic recording medium. However, since a granular film has weak magnetic coupling between the magnetic crystalline grains, the thermal stability of the dots depends on the magnetic crystalline grains, not on the dot volume as in the case of a continuous film. Therefore, to achieve high thermal stability, it is necessary to increase the magnetic anisotropy energy Kᵤ of the magnetic crystalline grains. As a result, the same problem as the problem with a conventional perpendicular magnetic recording medium is caused. Also, since there is a large variation in the magnetic crystalline grain size, the variation in the magnetic crystalline grain size is reflected in the magnetic characteristics of the dots. As a result, the variation in the magnetic characteristics becomes large among the dots. Therefore, it is not preferable to form a patterned medium with a CoCrPt-based granular film that is used in conventional perpendicular magnetic recording media.

JP-A 2003-77113 (KOKAI) discloses a perpendicular magnetic recording medium that includes a CoCr-based granular film and a rare-earth and transition metal alloy amorphous film as a technique for solving the problem of low thermal stability.

However, in a case where a patterned medium is formed with the film disclosed in JP-A 2003-77113 (KOKAI), the influence of the magnetic characteristics of the granular film is so large as to interfere with the domain wall motion, since the film thickness of the granular film is larger than the film thickness of the rare-earth and transition metal alloy amorphous film. As a result, a multi-domain state is easily formed in a dot, and the SN ratio is lowered. In a conventional perpendicular magnetic recording medium, it is preferable that the magnetic characteristics of the granular film have greater influence than the magnetic characteristics of the rare-earth and transition metal alloy amorphous film, and a multi-domain state is easily formed. In a patterned medium that requires a single-domain state in a dot, however, it is not preferable that the magnetic characteristics of the granular film have greater influence, and a multi-domain state is easily formed. Therefore, it is not preferable to form a patterned medium having the disclosed film structure.

JP-A 2003-22513 (KOKAI) discloses a two-layer perpendicular magnetic recording medium including a rare-earth and transition metal alloy amorphous film and a CoCr-based alloy crystalline film that are exchange coupled. However, the perpendicular magnetic recording medium disclosed in JP-A 2003-22513 (KOKAI) is a conventional perpendicular magnetic recording medium that is not patterned, and is not expected to be a patterned medium.

As will be described later, if a patterned medium is formed with the perpendicular magnetic recording medium disclosed in JP-A 2003-22513 (KOKAI), the obtained patterned medium is not a practical patterned medium with excellent thermal stability.

With those circumstances being taken into consideration, patterned media are expected to be used to realize higher density and larger capacity than those of the perpendicular magnetic recording type, and a magnetic material suitable for patterned media is being searched for.

The characteristics of a crystalline magnetic continuous film material include a hysteresis curve on which the nucleation field Hₙ and the coercivity H_{c} are as small as several hundreds of Oe in an As-grown film not subjected to fine processing. A magnetic material having minute portions characteristically has increases in the nucleation field Hₙ and the coercivity H_{c}, as a shape effect is added to the magnetic characteristics. However, even a magnetic material having minute portions has the same characteristics as those of an As-grown film, depending on the size of each minute portion, if the minute portions are relatively large.

Since a magnetic recording medium is one of the components of a magnetic recording and reproducing apparatus, it is necessary to provide head position control information within the medium. In a conventional perpendicular magnetic recording medium that is formed with an As-grown film, the position control information regions (the servo regions) of the head are formed by performing servo writing after the medium is completed. In a patterned medium, on the other hand, the position control information regions can be fine-processed at the same time as the fine processing of the bit regions. Accordingly, it is not necessary to perform servo writing.

The position control information regions of the head extend over the entire face in the disk radial direction, and some of the position control information patterns are much larger than the bit patterns of submicron size or even smaller. Accordingly, a patterned medium is formed with minute magnetic structures of various sizes. In a patterned medium, the magnetic characteristics such as the nucleation field Hₙ, the coercivity H_{c}, and the saturation magnetic field Hₛ greatly vary among the regions, for the above mentioned reasons. For example, in a bit region formed with magnetic dots, a shape magnetic anisotropy effect of the minute structure is added to the magnetic characteristics. Accordingly, the write magnetic field increases due to the minute portions. Also, since the magnetic dots are extremely small as described above, a variation is easily caused in the magnetic characteristics, due to a processed-shape variation, a relative proportion variation, a crystalline grain boundary variation, and the likes among the dots. Unlike the bit regions, the head position control information regions exhibit hysteresis characteristics similar to the hysteresis characteristics of an As-grown film, and the values Hₙ and H_{c} become smaller. As a result, reverse magnetic domains are generated due to a floating magnetic field, heat fluctuation, and the likes.

### SUMMARY OF THE INVENTION

The present invention has been made in view of these circumstances, and an object thereof is to provide a patterned perpendicular magnetic recording medium that has smaller write magnetic field and the variation of magnetic characteristics in the bit regions, generates fewer reversed magnetic domains in the position control information regions of the head, and has excellent thermal stability, and a magnetic recording and reproducing apparatus that includes the patterned perpendicular magnetic recording medium.

A patterned perpendicular magnetic recording medium according to a first aspect of the present invention includes: a nonmagnetic substrate; a soft magnetic base layer formed on the nonmagnetic substrate; a nonmagnetic intermediate layer formed on the soft magnetic base layer; and a perpendicular magnetic recording layer formed on the nonmagnetic intermediate layer, and including a stacked structure of a CoPt-based crystalline film having a Pt content in the range of 5 atomic percent to 35 atomic percent and a rare-earth and transition metal alloy amorphous film formed on the CoPt-based crystalline film, the CoPt-based crystalline film and the rare-earth and transition metal alloy amorphous film being exchange-coupled.

A magnetic recording and reproducing apparatus according to a second aspect of the present invention includes: a patterned perpendicular magnetic recording medium according to the first aspect, and a recording and reproducing head.

### BRIEF DESCRIPTION OF THE DRAWINGS

FIG. 1 is a cross-sectional view of a patterned perpendicular magnetic recording medium in accordance with a first embodiment of the present invention;

FIG. 2 is a plan view of the patterned perpendicular magnetic recording medium in accordance with the first embodiment;

FIG. 3 is a schematic view of a hysteresis curve in a case where the exchange coupling intensity low;

FIG. 4 is a perspective view of a magnetic recording and reproducing apparatus in accordance with a second embodiment of the present invention; and

FIG. 5 is a perspective view of the magnetic head assembly outside the actuator arm of the magnetic recording and reproducing apparatus of the second embodiment.

### DETAILED DESCRIPTION OF THE INVENTION

The following is a description of embodiments of the present invention, with reference to the accompanying drawings.

### First Embodiment

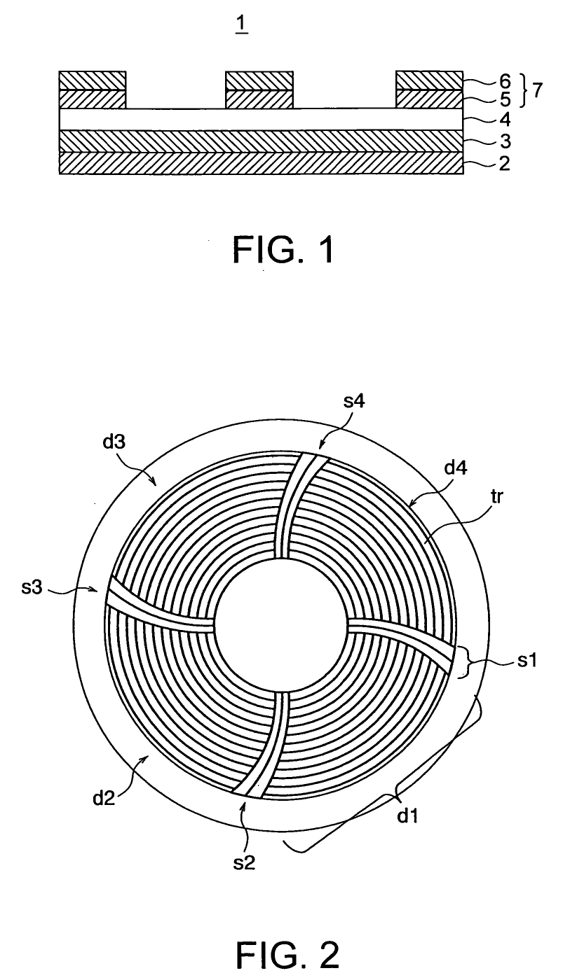

FIG. 1 is a cross-sectional view of a patterned perpendicular magnetic recording medium in accordance with a first embodiment of the present invention. FIG. 2 is a plan view of the patterned perpendicular magnetic recording medium. The patterned perpendicular magnetic recording medium 1 of this embodiment includes several bit regions, for example, four bit regions d1 through d4, and position control information regions (servo regions) s1 through s4 provided between the bit regions d1 through d4, as shown in FIG. 2. Each of the bit regions has tracks tr. Each of the position control information regions s1 through s4 is formed in the shape of an arc in conformity with the trajectory of the arm. The patterned perpendicular magnetic recording medium 1 of this embodiment has a structure in which a soft magnetic base layer 3, a nonmagnetic intermediate layer 4, and a perpendicular magnetic recording layer 7 are stacked in this order on a nonmagnetic substrate 2 in each of the bit regions and the position control information regions, as shown in FIG. 1. The perpendicular magnetic recording layer 7 has an exchange-coupled structure in which a CoPt-based crystalline film 5 and a rare-earth and transition metal alloy amorphous film 6 are stacked in this order. The CoPt-based crystalline film 5 and the rare-earth and transition metal alloy amorphous film 6 are arranged in a minute-shape pattern.

In this embodiment, the nonmagnetic substrate 2 may be a glass substrate or an alloy substrate such as a Si-based substrate, a C-based substrate, or an Al-based substrate.

Example materials that can be used for the soft magnetic base layer 3 include CoZrNb, CoB, CoTaZr, FeSiAl, FeTaC, CoTaC, NiFe, Fe, FeCoB, FeCoN, FeTaN, and CoIr. The soft magnetic base layer 3 may also be a so-called antiferromagnetically coupled structure in which a Ru film or the like is interposed between a lower soft magnetic base film and an upper soft magnetic base film to form a three-layer stacked structure, and the magnetization of the lower soft magnetic base film is antiferromagnetically coupled to the magnetization of the upper soft magnetic base film. The film thickness of the soft magnetic base layer 3 is controlled by adjusting the balance between the overwrite characteristics and the SN ratio.

In this embodiment, it is preferable that the nonmagnetic intermediate layer 4 is a crystalline alloy film that contains Ru, Re, Pt, Pd, or Ti. To achieve higher crystalline orientation for the perpendicular magnetic recording layer 7, it is preferable that the film thickness of the nonmagnetic intermediate layer 4 is in the range of 0.5 nm to 50 nm. The crystalline orientation plane should preferably be a (0002) plane in the case where the nonmagnetic intermediate layer 4 contains Ru, Re, or Ti, and should preferably be a (111) plane in the case where the nonmagnetic intermediate layer 4 contains Pt or Pd. With this arrangement, it is possible to obtain high magnetic anisotropic energy Kᵤ and high thermal stability. In the manufacture of the patterned medium, a dry etching procedure might be carried out with the use of an etching gas such as a CF₄ gas or a SF₆ gas. If such a dry etching procedure is included in the manufacture, the material to be subjected to the etching should have corrosion resistance against etching gases, so as to prevent degradation of the magnetic characteristics, deformation of the minute structure, and the likes due to corrosion, and prevent degradation of characteristics due to deterioration of the nonmagnetic intermediate layer 4. If the nonmagnetic intermediate layer 4 contains one of the above mentioned materials excluding Ti, the nonmagnetic intermediate layer 4 is desirable as an intermediate layer, having corrosion resistance against a dry etching gas such as a CF₄ gas or a SF₆ gas. If the nonmagnetic intermediate layer 4 contains Ti, corrosion is caused by an etching gas such as a CF₄ gas or a SF₆ gas. However, such a nonmagnetic intermediate layer exhibits corrosion resistance to an etching gas such as an O₂ gas. Therefore, it is possible to use such a Ti-containing layer as an intermediate layer, if an etching gas such as an O₂ gas is used. The nonmagnetic intermediate layer 4 of this embodiment may have a multilayer stacked structure formed with more than two layers.

The perpendicular magnetic recording layer 7 has a two-layer stacked structure in which the CoPt-based crystalline film 5 and the rare-earth and transition metal alloy amorphous film 6 are exchange-coupled, and are arranged in a minute-shape pattern. It is preferable that the rare earth material of the rare-earth and transition metal alloy amorphous film 6 is a heavy rare earth material. More specifically, it is possible to use Gd, Tb, Dy, Ho, or Er. By employing a heavy rare earth material, a nucleation field Hₙ of several kOe is obtained with an As-grown film. Also, since the saturation magnetization Mₛ is extremely small, the magnetic characteristics are not easily affected by a shape effect. It is not preferable to form a patterned medium with a single layer of a rare-earth and transition metal alloy amorphous film. For example, in a case where a heavy rare earth material is used as a rare earth material, the magnetization of the rare earth element is antiferromagnetically coupled to the magnetization of the transition metal, so as to form so-called ferrimagnetism. Therefore, as the saturation magnetization Mₛ becomes extremely small, a sufficient SN ratio cannot be obtained. In a case where a light rare earth material is used as a rare earth material, the magnetization of the rare earth element is ferromagnetically coupled to the magnetization of the transition metal, and the saturation magnetization Mₛ becomes larger. Also, with a light rare-earth and transition metal alloy amorphous material, large magnetic anisotropy energy Kᵤ cannot be obtained. Therefore, such a material is not suitable as a perpendicular magnetic recording layer, having a small nucleation field Hₙ, small coercivity H_{c}, and a small saturation magnetic field Hₛ.

Since the CoPt-based crystalline film 5 of this embodiment is a continuous film, the nucleation field Hₙ and the coercivity H_{c} are small and generate reversed magnetic domains in regions with relatively large minute portions such as the position control information regions of the head. Meanwhile, in the bit regions that are submicron minute portions or smaller portions, the coercivity H_{c} becomes larger as a shape anisotropy effect is added to the magnetic characteristics. As a result, the write magnetic field is increased.

By exchange-coupling the CoPt-based crystalline film 5, which is the first layer of the perpendicular magnetic recording layer 7, to the rare-earth and transition metal alloy amorphous film 6, which is the second layer of the perpendicular magnetic recording layer 7, the nucleation field Hₙ and the coercivity H_{c} in the position control information regions of the head can be increased by virtue of the rare-earth and transition metal alloy amorphous film 6, and generation of reversed magnetic domains can be prevented accordingly. This effect cannot be achieved in a case where a perpendicular magnetic recording layer is formed only with a CoPt-based crystalline film.

Also, as the coercivity H_{c} and the saturation magnetic field Hₛ can be reduced in the bit regions, an increase of the write magnetic field can be prevented. More specifically, it is preferable that the nucleation field Hₙ and the coercivity H_{c} are large in the position control information regions of the head if they are 1.5 kOe or greater (hereinafter denoted by Hₙₕₛ and H_{chs}, respectively) through magnetization curve measurement at a magnetic field sweep rate of approximately 1700 Oe/sec. Likewise, in the bit regions, it is preferable that the coercivity H_{c} and the saturation magnetic field Hₛ are small if they are 6 kOe or less and 9 kOe or less, respectively (hereinafter denoted by H_{cbs} and H_{sbs}, respectively).

It is preferable that the thickness of the CoPt-based crystalline film 5 is 5 nm or greater, the thickness of the rare-earth and transition metal alloy amorphous film 6 is in the range of 2 nm to 5 nm, and the thickness of the perpendicular magnetic recording layer 7 is 30 nm or less. Compared with a crystalline material, an amorphous material is more likely to be affected by side etching when RIE (Reactive Ion Etching) is performed during the procedure for forming the minute structure. Also, an amorphous material easily has burrs formed thereon due to reattachments and the likes at the time of milling. If the thickness of the rare-earth and transition metal alloy amorphous film 6 becomes larger than 5 nm, the influence of the deformation of the minute structure due to the side etching and the reattachments formed at the time of milling cannot be ignored in relation to the magnetic characteristics and the floating characteristics of the head. Therefore, it is preferable that the thickness of the rare-earth and transition metal alloy amorphous film 6 is as thin as possible within the range for achieving an appropriate nucleation field Hₙ. The film thicknesses can be checked by cross-sectional TEM (Transmission Electron Microscopy).

If the thickness of the perpendicular magnetic recording layer 7 is 30 nm or less, it is preferable that the thickness of the CoPt-based crystalline film 5, which is the first layer of the perpendicular magnetic recording layer 7, is as thick as possible, so as to maintain the thermal stability of the perpendicular magnetic recording layer 7. More specifically, the ratio between the energy ΔE required for a magnetization reversal and the thermal energy, which is the thermal stability index represented by ΔE/(k_{B}·T), needs to be 80 or higher. Here, k_{B} represents the Boltzmann's constant, and T represents the absolute temperature of the perpendicular magnetic recording layer 7.

In this embodiment, it is preferable that the Pt content in the CoPt-based crystalline film 5 is in the range of 5 atomic percent to 35 atomic percent, and is a continuous film. It is more preferable that the Pt content is in the range of 10 atomic percent to 25 atomic percent, so as to obtain high magnetic anisotropic energy Kᵤ and high thermal stability. If the Pt content is smaller than 5 atomic percent or greater than 35 atomic percent, the proportion of the fcc (face-centered cubic) structure is increased, and the magnetic anisotropic energy Kᵤ is reduced. As a result, high thermal stability cannot be maintained. Also, the CoPt-based crystalline film 5 should have corrosion resistance against dry etching gases such as a SF₆ gas and a CF₄ gas, so as to prevent degradation of the magnetic characteristics due to corrosion caused by a dry etching gas. In view of the above facts, it is preferable that the CoPt-based crystalline film 5 is formed with CoPt, CoCrPt, CoCrPtB, CoRuPt, CoRePt, CoPdPt, or the like. The Pt content can be measured by TEM-EDX (Transmission Electron Microscopy-Energy Dispersive X-ray spectroscopy) or the like.

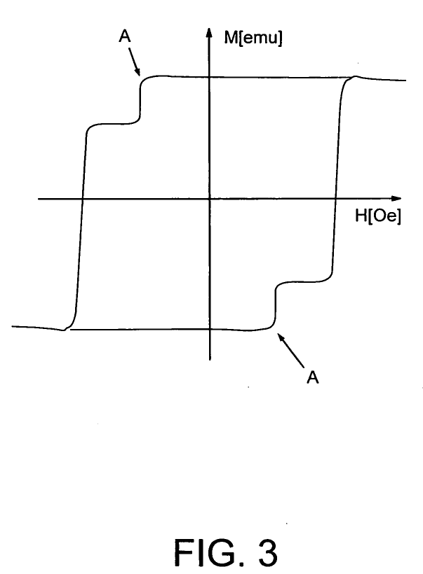

To further increase the thermal stability, it is preferable that there is strong exchange coupling between the CoPt-based crystalline film 5, which is the first layer of the perpendicular magnetic recording layer 7, and the rare-earth and transition metal alloy amorphous film 6, which is the second layer. The strength of the exchange coupling can be determined by the hysteresis curve. If the exchange coupling is weak, the hysteresis curve has the two-stage loop-like shape shown in FIG. 3 in the bit regions. As indicated by the regions A in FIG. 3, if the exchange coupling is weak, the magnetization of the rare-earth and transition metal alloy amorphous film 6, which has smaller coercivity than the CoPt-based crystalline film 5, is first reversed independently of the CoPt-based crystalline film 5. In such a situation, a decrease of the dot write magnetic field cannot be achieved, and a further increase in the thermal stability that should be achieved by forming the two-layer stacked structure cannot be achieved. By carrying out film formation at a low sputtering pressure of 1.0 Pa or less, strong exchange coupling can be achieved, with the hysteresis curve not forming a two-stage loop-like shape.

It is preferable that the film thickness of the perpendicular magnetic recording layer 7 is 30 nm or smaller. This is because, in the regions where the film thickness is greater than 30 nm, the coercivity H_{c} and the saturation magnetic field Hₛ are large, and writing with the magnetic field from the head becomes difficult. Furthermore, if the film thickness of the perpendicular magnetic recording layer 7 is greater than 30 nm, it becomes difficult to carry out a flattening etchback procedure by filling the groove portions in the patterned magnetic recording layer 7 with a nonmagnetic material.

The soft magnetic base layer 3, the nonmagnetic intermediate layer 4, and the perpendicular magnetic recording layer 7 of this embodiment can be formed by a vapor deposition technique and a sputtering technique. Also, the patterned perpendicular magnetic recording medium of this embodiment may be flattened by filling the groove portions with a nonmagnetic substance by an etchback technique or the like after the processing.

In the perpendicular magnetic recording medium disclosed in JP-A 2003-22513 (KOKAI), the bit thermal stability is defined by the volume of the rare-earth and transition metal alloy amorphous film. Therefore, the rare earth atomic content is controlled so as to obtain high magnetic anisotropic energy Kᵤ. However, the relative proportions in the CoCr-based alloy crystalline film are not specified in JP-A 2003-22513 (KOKAI).

In the patterned perpendicular magnetic recording medium of this embodiment, on the other hand, the volume of the magnetic body is determined by the pattern size. Therefore, the dot thermal stability cannot be defined by the volume of the thin rare-earth and transition metal alloy amorphous film 6. In such a situation, the dot thermal stability should be defined by the crystal magnetic anisotropy of the CoPt-based crystalline film 5, and the CoPt-based crystalline film 5 is required to have high magnetic anisotropic energy Kᵤ. The range of the Pt content that can achieve high magnetic anisotropic energy Kᵤ becomes important for the CoPt-based crystalline film 5. The perpendicular magnetic anisotropy of the rare-earth and transition metal alloy amorphous film 6 is formed when the magnetic anisotropy of the rare earth monoatoms is aligned in a direction perpendicular to the film plane by virtue of distortion caused by the sputtering. In a patterned medium, however, the distortion tends to be reduced by the patterning, and high magnetic anisotropy that is achieved in the case of a continuous film cannot be achieved.

In view of this, if a patterned medium is formed with the perpendicular magnetic recording medium disclosed in JP-A 2003-22513 (KOKAI), a practical patterned medium with high thermal stability cannot be obtained, since the relative proportion of the CoCr-based alloy crystalline film on which the dot thermal stability is to depend is not defined.

As described so far, this embodiment can provide a patterned perpendicular magnetic recording medium that has smaller write magnetic field and the variation of magnetic characteristics in the bit regions, generates fewer reversed magnetic domains in the position control information regions of the head, and has excellent thermal stability.

### EXAMPLES

In the following, patterned perpendicular magnetic recording media of this embodiment are described in greater detail through examples.

### Example 1

A method for manufacturing a patterned perpendicular magnetic recording medium in accordance with Example 1 of the present invention is now described.

First, the nonmagnetic glass substrate 2 is introduced into the vacuum chamber of a sputtering device of type c-3010, manufactured by Anelva Corp. The ultimate vacuum of the sputtering device is 1×10⁻⁵ Pa. After that, the following films are formed in order: a 100-nm thick Co₉₀Zr₅Nb₅ layer as the soft magnetic base layer 3, a 20-nm thick Ru layer as the nonmagnetic intermediate layer 4, a 10-nm thick (CoRu₂₀)₁₋ₓPtₓ film as the CoPt-based crystalline film 5 of the perpendicular magnetic recording layer 7, and a 3-nm thick Tb₁₈Co₈₂ film as the rare-earth and transition metal alloy amorphous film 6 of the perpendicular magnetic recording layer 7.

The (CoRu₂₀)₁₋ₓPtₓ film 5 of the perpendicular magnetic recording layer 7 is formed with an Ar pressure of 0.5 Pa and a supply power of 500 W, and the Tb₁₈Co₈₂ film 6 is formed with an Ar pressure of 0.5 Pa and a supply power of 500 W. The formation of all the films is room-temperature film formation involving DC sputtering. It is preferable that the sputtering pressure is 1.0 Pa or lower, so as to strengthen the exchange coupling between the CoPt-based crystalline film 5 and the rare-earth and transition metal alloy amorphous film 6.

When the minute structure is formed, the formation of the bit regions is carried out independently of the formation of the position control information regions of the head, so as to facilitate the magnetic characteristics measurement in each region.

To form the position control information regions of the head, a 100-nm thick SOG (Spin On Glass) film is formed by a spin coat technique on the medium surface, after film formation by a sputtering technique. A concavity and convexity pattern is then formed by a nanoimprint technique with the use of a Ni stamper that has a position control information pattern formed by an EB (Electron Beam) drawing technique and transferred thereon. The imprint residue is removed by RIE using a CF₄ gas. After that, etching is performed on the perpendicular magnetic recording layer 7 by Ar ion milling, and the SOG mask is removed by RIE using a CF₄ gas. After the removal of the mask, a 10-nm thick C film is formed as a protection film, and perfluoropolyether is applied as a lubricant agent layer onto the entire surface by a dipping technique. In this manner, the position control information pattern is formed on the entire disk surface.

On the other hand, to form the bit regions, a self-organization phenomenon is used so as to achieve the magnetic characteristics of a smaller-sized pattern. It is also possible to form a bit pattern arrangement by the same technique as the technique used in the formation of the position control information regions of the head. Further, it is also possible to form a patterned perpendicular magnetic recording medium that can be mounted on a magnetic recording and reproducing apparatus with the use of a Ni stamper that has the position control information regions of the head and the bit pattern arrangement regions drawn on the same substrate by the EB drawing technique.

To form the bit regions, film formation is carried out by a sputtering technique, and PS (polystyrene)-PMMA (polymethylmethacrylate) diblock polymer dissolved in an organic solvent is then applied by a spin coat technique. A heat treatment is carried out at 200° C. The PMMA phase-separated by performing RIE using an O₂ gas is removed, and SOG spin coating is performed. RIE using an O₂ gas is then performed again, so as to form a dotted mask made of SOG. After that, etching is performed on the perpendicular magnetic recording layer by Ar ion milling, and the SOG mask is removed by performing RIE using a CF₄ gas. After the removal of the mask, a 10-nm thick C film is formed as a protection film, and perfluoropolyether is applied as a lubricant agent layer by a dipping technique. In this manner, the bit pattern arrangement is formed on the entire disk surface. By varying the molecular weight of the polymer, four different dot patterns of 300 nm, 200 nm, 100 nm, and 45 nm in dot pitch are formed with the land-to-groove ratio of 1.0.

When the magnetization curves of the obtained media are measured with the use of the magnetooptical Kerr effect, no stage-like regions are seen in the magnetization curves, and the strong exchange coupling between the (CoRu₂₀)₁₋ₓPtₓ of the CoPt-based crystalline film 5 and the Tb₁₈Co₈₂ of the rare-earth and transition metal alloy amorphous film 6 is observed.

Table 1 shows the values of the nucleation field Hₙ, the coercivity H_{c}, and the saturation magnetic field Hₛ of the medium of 45 nm in pitch.

TABLE 1

| | Hₙ[kOe] | H_{c}[kOe] | Hₛ[kOe] |
|---|---|---|---|
| Bit regions | 4.6 | 5.8 | 7.2 |
| Position control | 2.1 | 2.7 | 3.2 |
| information regions | | | |

The Pt content in the CoPt-based crystalline film 5 is 15 atomic percent. The magnetic field sweep rate at the time of the measurement is approximately 1700 Oe/sec. It is preferable that the nucleation field Hₙ, the coercivity H_{c}, and the saturation magnetic field Hₛ are large, as long as the nucleation field Hₙ and the coercivity H_{c} in the position control information regions of the head are 1.5 kOe or greater (hereinafter denoted by Hₙₕₛ and H_{chs}, respectively) in the measurement of the magnetization curve at the magnetic field sweep rate of approximately 1700 Oe/sec. If the nucleation field Hₙ and the coercivity H_{c} are smaller than 1.5 kOe, servo tracking cannot be performed after the medium is mounted on a magnetic recording and reproducing apparatus due to generation of reversed magnetic domains caused by a floating magnetic field, heat fluctuation, and the likes.

Likewise, in the bit regions, it is preferable that the coercivity H_{c} and the saturation magnetic field Hₛ are small, as long as the coercivity H_{c} and the saturation magnetic field Hₛ are 6 kOe or smaller and 9 kOe or smaller, respectively (hereinafter denoted by H_{cbs} and H_{sbs}, respectively). If the coercivity H_{c} and the saturation magnetic field Hₛ are greater than the respective values, bit writing cannot be performed in a magnetic field from the head.

In the measured medium, the nucleation field Hₙ, the coercivity H_{c}, and the saturation magnetic field Hₛ in the position control information regions of the head are 2.1 kOe, 2.7 kOe, and 3.2 kOe, respectively, and the nucleation field Hₙ, the coercivity H_{c}, and the saturation magnetic field Hₛ in the bit regions are 4.6 kOe, 5.8 kOe, and 7.2 kOe, respectively, which satisfy the Hₙₕₛ, H_{chs}, H_{cbs}, and H_{sbs} requirements. After DC (Direct Current) demagnetizing performed on the medium having the position control information regions of the head formed thereon, the MFM (Magnetic Force Microscopy) is measured to confirm that there is not a reversed magnetic domain.

Further, the variation of the magnetic characteristics of the medium having the 45-nm pitch dot regions formed thereon is measured. SFD (Switching Field Distribution) is used as the indicator of the magnetic characteristics variation, and the measurement is carried out by the ΔH_{cr}/H_{cr} method. Here, H_{cr} represents the remanent coercivity, and ΔH_{cr} represents the variation of the remanent coercivity. The measured ΔH_{cr}/H_{cr} is 0.33. As in the case shown in Table 1, the Pt content in the CoPt-based crystalline film 5 is 15 atomic percent.

In the measurement of the remanent magnetization curve using the magnetooptical Kerr effect, the dependence of the remanent coercivity H_{cr} on the induced field rate is also measured, and the thermal stability index is measured by performing fitting in accordance with the Sherlock's equation. The thermal stability is represented by ΔE/(k_{B}·T), which is the ratio between the energy required for a magnetization reversal and the thermal energy, and should be 80 or greater. The medium measured in this example has a high thermal stability index ΔE/(k_{B}·T) of 143.

In cases where Re, Pt, or Pd is used for the nonmagnetic intermediate layer 4, and where Gd, Dy, Ho, or Er is used as the rare earth material, the Hₙₕₛ, H_{chs}, H_{cbs}, and H_{sbs} requirements are satisfied, and a thermal stability index of 80 or higher is obtained. Also, the value of ΔH_{cr}/H_{cr} is approximately 0.3.

### Comparative Example 1

As Comparative Example 1, the same patterned perpendicular magnetic recording medium as that of Example 1 is formed, except that the perpendicular magnetic recording layer 7 is replaced with a 10-nm thick granular film made of (Co₁₀Cr₁₆Pt₇₄)₉₂−SiO₂. The SFD of the 45-nm pitch medium is measured in the same manner as in Example 1. The result of the measurement shows that the value of ΔH_{cr}/H_{cr} is approximately 0.61. Compared with the medium of Example 1, the variation is almost twice as large. The thermal stability index is also measured in the same manner as in Example 1. The result of the measurement shows that ΔE/(k_{B}·T) is 73, which is smaller than that of the medium of Example 1, and the terminal stability is poor. Table 2 shows those results.

TABLE 2

| | ΔH_{cr}/H_{cr} | ΔE/(k_{B} · T) |
|---|---|---|
| Example 1 | 0.33 | 143 |
| Comparative Example 1 | 0.61 | 73 |

As can be seen from the above results, with the use of the patterned perpendicular magnetic recording medium of Example 1, the magnetic characteristics variation becomes smaller and the thermal stability becomes higher than those of a patterned medium including a granular film.

### Comparative Example 2

As Comparative Example 2, a patterned medium is formed in the same manner as in Example 1, except that the perpendicular magnetic recording layer is a 10-nm thick Co₈₀Pt₂₀ film. The magnetization curve of the obtained medium is measured in the same manner as in Example 1. The result of the measurement shows that the nucleation field Hₙ, the coercivity H_{c}, and the saturation magnetic field Hₛ in the position control information regions of the head are 0.6 kOe, 0.6 kOe, and 0.6 kOe, respectively, and the nucleation field Hₙ, the coercivity H_{c}, and the saturation magnetic field Hₛ in the 45-nm pitch bit regions are 7.5 kOe, 9.3 kOe, and 11.2 kOe, respectively. After DC demagnetizing performed on the position control information regions of the medium, the MFM is measured to confirm that there are reversed magnetic domains.

It is confirmed that, with the use of the patterned perpendicular magnetic recording medium of Example 1, the values in the position control information regions of the head are Hₙₕₛ and H_{chs} or greater, respectively, and the values in the bit regions are H_{cbs} and H_{sbs} or smaller, respectively. Accordingly, generation of reversed magnetic domains can be prevented.

In Example 1 and Comparative Example 2, the hysteresis characteristics of the patterns of 300 nm, 200 nm, and 100 nm in pitch are measured in the same manner. Table 3 shows the results of the measurement. As can be seen from Table 3, in the 100-nm pitch pattern, the values H_{c} and Hₛ do not satisfy H_{cbs} and H_{sbs}. Accordingly, it is confirmed that the effect to reduce the write magnetic field in the bit regions in accordance with this embodiment can be achieved where the pitch is 100 nm, or the dot size is 50 nm or smaller.

TABLE 3

| | Dot pitch [nm] | | | | | |
|---|---|---|---|---|---|---|
| | 300 | | 200 | | 100 | |
| | Hc | Hs | Hc | Hs | Hc | Hs |
| | [kOe] | [kOe] | [kOe] | [kOe] | [kOe] | [kOe] |
| Example 1 | 3.6 | 3.9 | 4.3 | 5.1 | 4.7 | 5.8 |
| Comparative | 2.1 | 2.9 | 4.1 | 5.5 | 7.9 | 9.5 |
| Example 2 | | | | | | |

### (Example 2)

Next, patterned perpendicular magnetic recording media in accordance with Example 2 of the present invention are described. In this example, three different types of patterned perpendicular magnetic recording media are formed by the same method as the medium manufacture method of Example 1. In the three media, the Pt contents x in the (CoRu₂₀)₁₋ₓPtₓ films 5 are 5 atomic percent, 15 atomic percent, and 35 atomic percent, respectively. The pitch size of the bit regions of each medium is 45 nm.

The thermal stability index of each of those media is measured in the same manner as in Example 1. The results of the measurement show that a high thermal stability index of 80 or more is obtained with any of the Pt proportions. Also, the Hₙₕₛ, H_{chs}, H_{cbs}, and H_{sbs} requirements are satisfied in all the media. Through MFM measurement carried out after DC demagnetizing performed on the position information control regions of the head, no reversed magnetic domains are observed. The SFD measurement is also carried out in the same manner as in Example 1. The result of the measurement shows that the value of ΔH_{cr}/H_{cr} is approximately 0.3.

### Comparative Example 3

As Comparative Example 3, patterned media are formed in the same manner as in Example 2, except that the Pt contents x in the (CoRu₂₀)₁₋ₓPtₓ films are 2 atomic percent, 40 atomic percent, and 50 atomic percent, respectively.

The medium having the Pt content of 2 atomic percent is not a perpendicular magnetization film, but an in-plane magnetization film. In the other media, the Hₙₕₛ, H_{chs}, H_{cbs}, and H_{sbs} requirements are satisfied, and the value of ΔH_{cr}/H_{cr} is approximately 0.3. However, when the thermal stability index is measured in the same manner as in Example 2, the results of the measurement show that the thermal stability indexes in the media having the Pt contents of 40 atomic percent and 50 atomic percent are 60 and 43, respectively, which are not sufficient. Table 4 shows those results.

TABLE 4

Pt content x [at. %]

| | 2 | 5 | 15 | 35 | 40 | 50 |
|---|---|---|---|---|---|---|
| ΔE/(k_{B} · T) | — | 81 | 143 | 110 | 60 | 43 |

As can be seen from the above results, as long as the Pt content in the CoPt-based crystalline film is within the range specified in Example 2, writing can be performed in a magnetic field from the head, no magnetic domains are formed in the position control information regions of the head, and a high thermal stability index of 80 or more can be achieved.

### Example 3

Next, patterned perpendicular magnetic recording media in accordance with Example 3 of the present invention are described. In this example, five different types of patterned perpendicular magnetic recording media are formed by the same method as the medium manufacture method of Example 1. In the five media, the film thicknesses of the (CoRu₂₀)₈₅Pt₁₅ films 5 are 5 nm, 10 nm, 15 nm, 20 nm, and 27 nm, respectively. The pitch size of the bit regions of each medium is 45 nm. The other conditions are the same as those of Example 1.

The magnetization curves of the obtained media are measured, and the results of the measurement show that the Hₙₕₛ, H_{chs}, H_{cbs}, and H_{sbs} requirements are satisfied in all the media. When the thermal stability is measured, the results of the measurement show that the thermal stability index of 80 or higher is achieved with any of the above film thicknesses. Through MFM measurement carried out after DC demagnetizing performed on the position control information regions of the head, no reversed magnetic domains are observed. The SFD measurement is also carried out, and the result of the measurement shows that the value of ΔH_{cr}/H_{cr} is approximately 0.3.

### Comparative Example 4

As Comparative Example 4, three different types of patterned perpendicular magnetic recording media are formed. Those patterned perpendicular magnetic recording media are the same as those of Example 3, except that the film thicknesses of the (CoRu₂₀)₈₅Pt₁₅ films are 2 nm, 40 nm, and 50 nm, respectively.

The magnetization curves of the obtained media of Comparative Example 4 are measured, and the results of the measurement show that the Hₙₕₛ and H_{chs} requirements are satisfied in the position control information regions of the heads of all the media, but the H_{cbs} and H_{sbs} requirements are not satisfied, since the coercivity H_{c} and the saturation magnetic field Hₛ in the bit regions are large in the media having the 40-nm and 50-nm thick (CoRu₂₀)₈₅Pt₁₅ films. When the thermal stability is measured, the results of the measurement show that the thermal stability of the medium having the 2-nm thick (CoRu₂₀)₈₅Pt₁₅ film is not sufficient. Table 5 shows those results.

TABLE 5

| | CoRuPt film thickness t [nm] | | | | | | | |
|---|---|---|---|---|---|---|---|---|
| | 2 | 5 | 10 | 15 | 20 | 27 | 40 | 50 |
| Hc | 3.8 | 4.1 | 4.7 | 5.1 | 5.6 | 6 | 6.6 | 7.3 |
| [kOe] | | | | | | | | |
| Hs | 5.9 | 6.4 | 6.9 | 7.6 | 8.1 | 8.5 | 9.8 | 10.7 |
| [kOe] | | | | | | | | |
| ΔE/ | 52 | 81 | 143 | 151 | 157 | 168 | 170 | 168 |
| (k_{B} · T) | | | | | | | | |

As can be seen from the above results, to satisfy the Hₙₕₛ and H_{chs} requirements and maintain sufficient thermal stability, and to achieve the coercivity H_{c} and the saturation magnetic field Hₛ of the bit regions in such a range as to enable writing in a magnetic field from the head (H_{chs} and H_{sbs} or lower), the film thickness of the perpendicular recording layer should be 30 nm or smaller, and the film thickness of the CoPt-based crystalline film should be 5 nm or greater.

### Example 4

Next, patterned perpendicular magnetic recording media in accordance with Example 4 of the present invention are described. In this example, patterned perpendicular magnetic recording media are formed by the same method as the medium manufacture method of Example 1. In those media, the film thickness of each (CoRu₂₀)₁₋ₓPtₓ film 5 is 5 nm, and the film thicknesses of the Tb₁₈Co₈₂ films 6 are 2 nm and 5 nm. The other conditions are the same as those of Example 1.

A durability test is conducted on the obtained media mounted on a floating-type recording and reproducing head with a floating distance of 12 nm at 4200 rpm. The floating state of the head is stabilized, and the head lasts several days to one week.

### Comparative Example 5

As Comparative Example 5, a patterned perpendicular magnetic recording medium is formed. The patterned perpendicular magnetic recording medium is the same as that of Example 4, except that the film thickness of the Tb₁₈Co₈₂ film is 7 nm. The same durability test as that in Example 4 is conducted with the use of the obtained medium. The result of the test shows that the floating state of the head is not stabilized, and the recording and reproducing head breaks down in a few hours. The medium of this comparative example is examined through cross-sectional TEM. The result of the examination shows that there are protrusive burrs formed on the rare-earth and transition metal alloy amorphous film due to the reattachment caused at the time of milling.

As can be seen from the above results, the film thickness of the rare-earth and transition metal alloy amorphous film should be in the range of 2 nm to 5 nm.

### Second Embodiment

Next, a magnetic recording and reproducing apparatus in accordance with a second embodiment of the present invention is described. The magnetic recording medium in accordance with the first embodiment illustrated in FIGS. 1 and 2 can be mounted on the magnetic recording and reproducing apparatus.

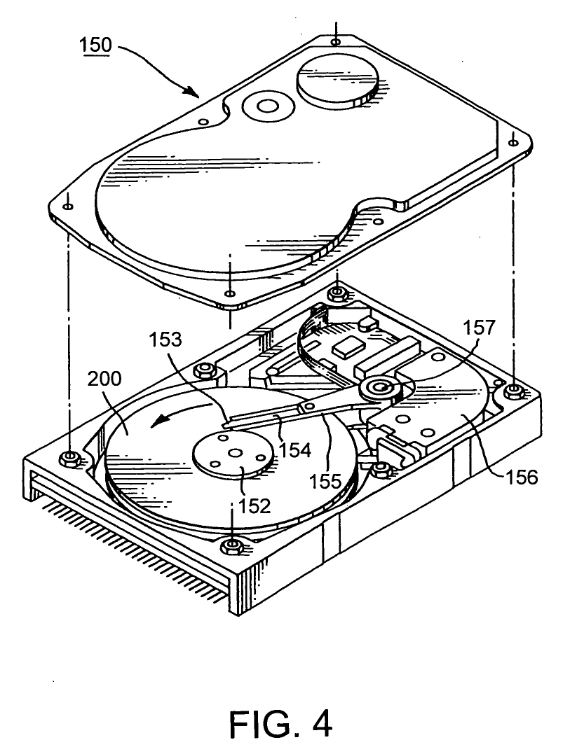

FIG. 4 is a perspective view schematically showing the structure of the magnetic recording and reproducing apparatus. The magnetic recording and reproducing apparatus 150 of this embodiment is an apparatus that includes a rotary actuator. In FIG. 4, a magnetic recording disk 200 for perpendicular recording is mounted onto a spindle 152, and is rotated in the direction of the arrow A by a motor (not shown) that responds to a control signal supplied from a drive controller (not shown). The magnetic disk 200 is a patterned perpendicular magnetic recording medium in accordance with the first embodiment. A head slider 153 that reproduces the record of information stored in the magnetic disk 200 is attached to the top end of a suspension 154 in the form of a thin film. The head slider 153 has a magnetic head according to one of the examples. The magnetic head is mounted onto a portion in the vicinity of the top end of the head slider 153.

When the magnetic disk 200 revolves, the air nearing surface (ABS) of the head slider 153 is held at a predetermined floating distance from the surface of the magnetic disk 200.

The suspension 154 is connected to one end of an actuator arm 155 that has a bobbin portion for holding a drive coil (not shown) and the likes. A voice coil motor 156 that is a kind of a linear motor is connected to the other end of the actuator arm 155. The voice coil motor 156 is formed with the drive coil (not shown) wound around the bobbin portion of the actuator arm 155, and a magnetic circuit that includes permanent magnets arranged to sandwich the coil in between and facing yokes.

The actuator arm 155 is held by ball bearings (not shown) provided at the top and bottom portions of a fixed shaft 157. The actuator arm 155 is slidably rotated by the voice coil motor 156.

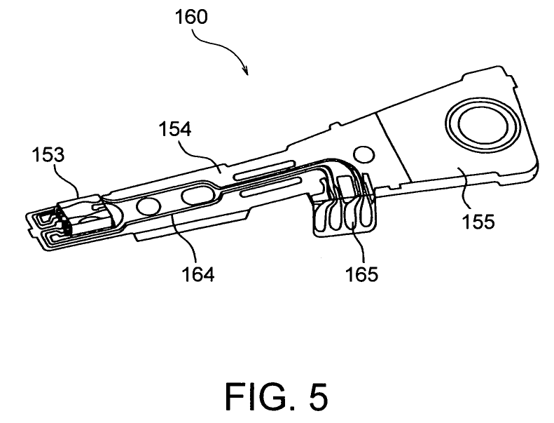

FIG. 5 is an enlarged perspective view of the magnetic head assembly including the actuator arm 155 and the components provided on the edge side of the actuator arm 155. The magnetic head assembly 160 includes the actuator arm 155 having the bobbin portion for holding the drive coil and the likes, and the suspension 154 is connected to one end of the actuator arm 155.

The head slider 153 equipped with the magnetic head is attached to the top end of the suspension 154. The suspension 154 has lead lines 164 for writing and reading signals, and the electrodes of the magnetic head incorporated into the head slider 153 are electrically connected to the lead lines 164. In FIG. 5, reference numeral 154 indicates the electrode pads of the magnetic head assembly 160. There is the predetermined floating distance is kept between the air bearing surface (ABS) of the head slider 153 and the surface of the magnetic disk 200.

As described so far, the present invention can provide a patterned perpendicular magnetic recording medium that has fewer write magnetic fields in the bit regions, generates fewer reversed magnetic domains in the position control information regions of the head, and has excellent thermal stability. The present invention can also provide a magnetic recording and reproducing apparatus that includes the patterned perpendicular magnetic recording medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A patterned perpendicular magnetic recording medium comprising:
a nonmagnetic substrate;
a soft magnetic base layer formed on the nonmagnetic substrate;
a nonmagnetic intermediate layer formed on the soft magnetic base layer; and
a perpendicular magnetic recording layer formed on the nonmagnetic intermediate layer, and including a stacked structure of a CoPt-based crystalline film having a Pt content in the range of 5 atomic percent to 35 atomic percent and a rare-earth and transition metal alloy amorphous film formed on the CoPt-based crystalline film, the CoPt-based crystalline film and the rare-earth and transition metal alloy amorphous film being exchange-coupled.

2. The medium according to claim 1, wherein the perpendicular magnetic recording layer has a thickness of 30 nm or smaller.

3. The medium according to claim 1, wherein the CoPt-based crystalline film has a thickness of 5 nm or greater.

4. The medium according to claim 1, wherein the rare-earth and transition metal alloy amorphous film has a thickness in the range of 2 nm to 5 nm.

5. The medium according to claim 1, wherein the rare-earth and transition metal alloy amorphous film is an amorphous alloy containing one of Gd, Tb, Dy, Ho, and Er.

6. The medium according to claim 1, wherein the nonmagnetic intermediate layer is a crystalline alloy containing one of Ru, Re, Pt, Pd, and Ti.

7. A magnetic recording and reproducing apparatus comprising a patterned perpendicular magnetic recording medium according to claim 1, and a recording and reproducing head.

8. The apparatus according to claim 7, wherein the perpendicular magnetic recording layer has a thickness of 30 nm or smaller.

9. The apparatus according to claim 7, wherein the CoPt-based crystalline film has a thickness of 5 nm or greater.

10. The apparatus according to claim 7, wherein the rare-earth and transition metal alloy amorphous film has a thickness in the range of 2 nm to 5 nm.

11. The apparatus according to claim 7, wherein the rare-earth and transition metal alloy amorphous film is an amorphous alloy containing one of Gd, Tb, Dy, Ho, and Er.

12. The apparatus according to claim 7, wherein the nonmagnetic intermediate layer is a crystalline alloy containing one of Ru, Re, Pt, Pd, and Ti.
